(19) United States
(12) Patent Application Publication
(10) Pub. No.: US 2007/0215272 A1
(43) Pub. Date: Sep. 20, 2007

(54) GUIDE TAPE

(75) Inventors: Curtis Patrick TAYLOR, Chagrin Falls, OH (US); Stephen Edward Mika, Cleveland Hgts, OH (US)

Correspondence Address: PILLSBURY WINTHROP SHAW PITTMAN, LLP, P.O. BOX 10500, MCLEAN, VA, 22102, US

(73) Assignee: Process4, Inc., Chagrin Falls, OH (US)

(21) Appl. No.: 11/677,814

(22) Filed: Feb. 22, 2007

Related U.S. Application Data
(60) Provisional application No. 60/775,341, filed on Feb. 22, 2006.

(51) Int. Cl. B32B 38/04; B32B 37/12

(52) U.S. Cl. 156/250; 156/267

(57) ABSTRACT

A cutting guide includes an adhesive tape and two longitudinally-extending parallel guide elements connected to the adhesive tape. The guide tape may be adhered to a work piece to help guide a cutting device along a straight or curved cutting path defined between the wires.

### CROSS REFERENCE TO RELATED APPLICATIONS

The present application claims the benefit of U.S. provisional application No. 60/775,341, filed Feb. 22, 2006, and is hereby incorporated in its entirety by reference.

### BACKGROUND OF THE INVENTION

1. Field of the Invention

The present invention relates to devices and methods for making straight cuts, scores, and/or marks on work pieces.

2. Description of Related Art

Cutting a straight line on a work piece such as paper, cardstock, fabric etc. with a pair of scissors or a knife is difficult. People frequently first draw a straight line on the work piece to guide subsequent cutting. However, depending on the type or work piece and ultimate purpose of the work piece, it may be undesirable or difficult to draw such a line.

A straight edge (e.g., a straight-edged ruler) is sometimes used in conjunction with a knife to guide the knife's blade along a straight line. However, it is frequently difficult to follow the straight edge exactly. It is also difficult to accurately reposition the straight edge if the cut line is longer than the straight edge, or if the straight edge is shifted during use. Furthermore, when a user uses his/her own hand to hold down the straight edge, the knife's blade comes close to the user's fingers, which increases the possibility of cutting the user's fingers if his/her fingers or the knife blade slip.

### BRIEF SUMMARY OF THE INVENTION

An aspect of one or more embodiments of the present invention provides tape that includes two elongated guide elements that guide a cutting device along a cutting path on disposed between the wires on a work piece on which the tape is adhered.

Another aspect of one or more embodiments of the present invention provides longitudinally-elongated adhesive tape that includes a longitudinally extending linear indicia on it to provide a straight line once the tape is adhered to a work piece.

Another aspect of one or more embodiments of the present invention provides adhesive tape with length measurement indicia thereon to facilitate measuring distances on the work piece on which the tape is adhered.

Additional and/or alternative advantages and salient features of the invention will become apparent from the following detailed description and claims, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a top view of guide tape according to an embodiment of the present invention;

FIG. 2 is a cross-sectional view of the guide tape illustrated in FIG. 1, taken along the line 2-2 in FIG. 1;

FIG. 3 is a cross-sectional view of guide tape according to an alternative embodiment of the present invention;

FIG. 4 is a perspective view of the guide tape and release liner illustrated in FIG. 1;

FIG. 5 is a perspective view of the guide tape of FIG. 1 partially lifted away from the release liner;

FIG. 6 is a perspective view showing the guide tape of FIG. 1 adhered to a work piece;

FIG. 7 is a perspective view of the guide tape and work piece illustrated in FIG. 6;

FIG. 8 is a perspective view of the guide tape and work piece illustrated in FIG. 6;

FIG. 9 is a top view of guide tape according to an alternative embodiment of the present invention; and

FIG. 10 is a cross-sectional view of guide tape according to an alternative embodiment of the present invention.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

### DETAILED DESCRIPTION OF EMBODIMENTS OF THE INVENTION

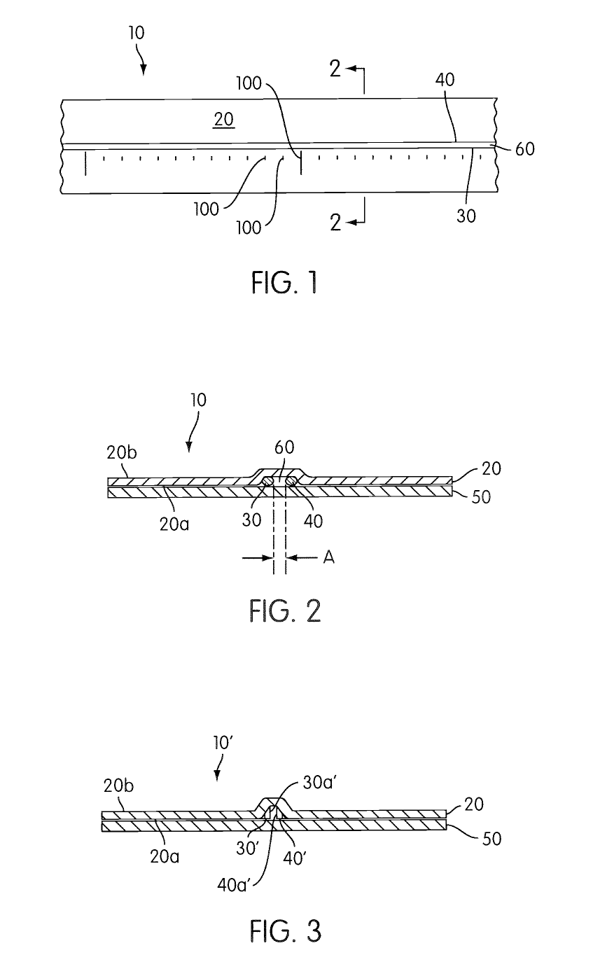

FIGS. 1 and 2 illustrate guide tape 10 according to an embodiment of the present invention. The guide tape 10 comprises adhesive tape 20 and two guide wires 30, 40 (or guide elements). The guide tape 10 may be releasably adhered to a release liner 50.

The adhesive tape 20 includes an adhesive side 20a. The adhesive tape 20 may be clear like transparent packaging tape, or opaque like masking tape. The adhesive side 20a preferably has a repositionable adhesive, but may alternatively include any other suitable type of adhesive. The adhesive tape 20 may comprise a thin, flexible material such as oriented polypropylene or other thermoplastic. The adhesive tape 20 may be conventional packaging tape. The adhesive tape 20 is preferably thin enough that it may be easily cut in either the longitudinal or transverse direction using a cutting device such as a knife blade or pair of scissors. According to various embodiments of the present invention, the adhesive tape may be less than 100 mils thick, less than 50 mils thick, less than 25 mils thick, less than 15 mils thick, less than 10 mils thick, less than 7 mils thick, or less than 4 mils thick. According to one embodiment, the adhesive tape 20 comprises 2 inch wide, 3 mil thick, transparent packaging tape.

The wires 30, 40 connect to the adhesive tape 20 such that the wires 30, 40 are substantially parallel to each other and run in a longitudinal direction of the adhesive tape 20. As shown in FIG. 2, the wires 30, 40 are spaced from each other by a gap A. The gap between the wires 30, 40 defines a longitudinally extending cutting path 60. The gap A is preferably dimensioned to enable a cutting device to extend between the wires 30, 40 and through an underlying work piece. The gap A is preferably smaller than ¼ inch, but may also be smaller than ⅛ inch, smaller than 1/16 inch, or even smaller than 1/32 inch. In one embodiment, the gap A is about 1/32 inch. According to another embodiment, the wires 30, 40 touch each other such that the distance A is zero. In such an embodiment, when the cutting device presses between the wires 30, 40, the cutting device separates the wires 30, 40, while the wires 30, 40 keep the cutting device precisely positioned between the wires 30, 40.

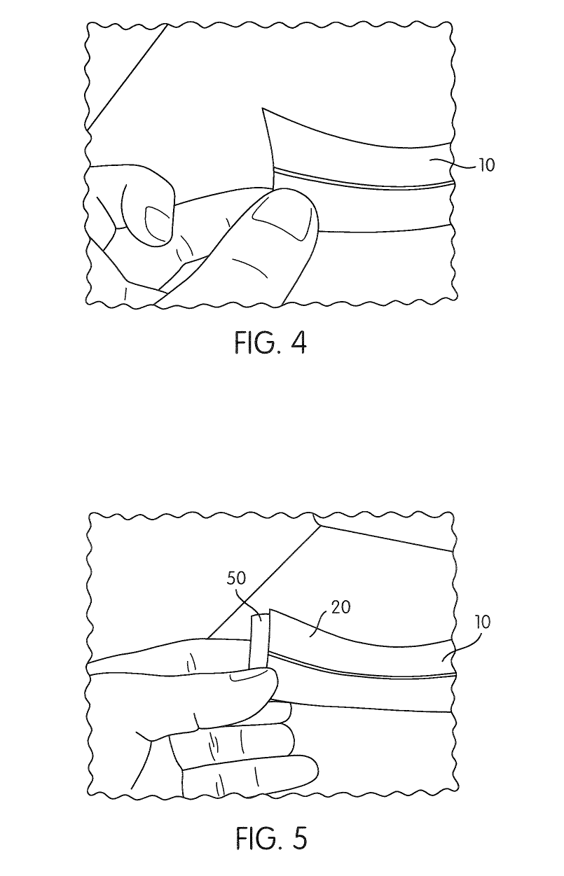

In the embodiment illustrated in FIG. 2, the wires 30, 40 have generally circular cross-sections. However, the wires 30, 40 may have a variety of other cross-sectional shapes without deviating from the scope of the present invention. For example, FIG. 3 illustrates an alternative guide tape 10′ in which wires 30′, 40′ have right-triangular cross-sections. Facing surfaces 30a′, 40a′ of the wires 30′, 40′ are generally planar, are spaced from each other, and are generally parallel to each other. The surfaces 30a′, 40a′ provide guiding surfaces for a cutting device such as a knife blade. Alternatively, the wires 30, 40 may have a variety of other cross-sectional shapes (e.g., rectangular, pie-piece-shaped, polygonal, semi-circular, etc.) without deviating from the scope of the present invention.

FIG. 10 illustrates guide tape 10″ according to an alternative embodiment of the present invention. The guide tape 10″ is similar to the guide tape 10′ except that the orientation of the right-triangle cross-sectioned guide wires 30″, 40″ is shifted such that the hypotenuse sides of the right triangles face each other and define a valley therebetween. The valley guides a cutting device into the cutting path 60″ defined between the wires 30″, 40″. According to an alternative embodiment of the present invention, the hypotenuse sides of the right triangles face the backing liner 50 to steady the position of the guide wires relative to the underlying work piece.

The wires 30, 40 may alternatively comprise thin, flat strips. These strips may have a substantially greater lateral width compared to their thickness. Other possible variations may be used.

The wires 30, 40 (or guide elements) preferably comprise a strong, elastically resilient material that will guide a cutting device between the wires 30, 40, while discouraging the cutting device from cutting through the wires 30, 40 and/or deviating from the cutting path 60. For example, the wires 30, 40 may comprise a hard thermoplastic, polypropylene, polyester, nylon, metal, or other suitable material. The elastic memory of the wire 30, 40 material is preferably limited so that it tends to straighten after being bent (e.g., after being unrolled from a roll of guide tape 10). Thermoplastics are therefore preferred because they tend to have less elastic memory than materials such as metal. On the other hand, metal may be preferable in certain embodiments because of its strength, including its resistance to cutting and deformation. In other embodiments, thermoplastics may be preferred over metal because they tend to be easier to cut when a user chooses to cut the guide tape 10 in a transverse direction (e.g., to cut a piece of the guide tape 10 off of a roll of guide tape 10). It is preferable that the user can use the same cutting device to transversely cut the guide tape 10 as is used to cut an underlying work piece. For example, a user who uses high quality shears to cut fabric may desire to use the shears to transversely cut the guide tape 10 without adversely dulling the shears on metal wires 30, 40. Alternatively, if a user uses a utility knife to cut the guide tape 10 and underlying work piece, the user may not be concerned about dulling an easily replaceable utility blade. In such a case, it may be more useful to provide a stronger wire 30, 40 material such as metal. Accordingly, the material used for the guide wires 30, 40 may be chosen in view of the tape's intended use.

In the embodiments illustrated in FIGS. 1-3, the wires 30, 40, 30′, 40′ connect to the adhesive tape 20 via adhesive on the adhesive side 20a of the adhesive tape 20. The guide tape 10 may therefore be manufactured by continuously applying the wires 30, 40 to the adhesive tape 20 as the adhesive tape is unwound from one supply roll and rewound onto a second roll. The release liner 50 may be adhered to the adhesive tape 20 during this process after the wires 30, 40 are applied to the tape 20, or simultaneously as the wires 30, 40 are being applied. The release liner 50 preferably adheres to the adhesive side 20a of the adhesive tape 20 with a very low tack that enables a user to easily peel/release the adhesive tape 20 away from the release liner 50. The release liner 50 may comprise a release material such as the release liner used in connection with conventional double-sided tape. For example, a silicone based release coating may be provided on the surface of the liner 50 that engages the adhesive.

When the guide tape 10 with release liner 50 is rolled up during manufacturing, the release liner 50 tends to help avoid kinking of the tape 20, which might otherwise result from rolling the tape 20 with the thicker wires 30, 40 onto a roll. Use of the release liner 50 may enable a user to cut a selected length of guide tape 10 and properly position it on a work piece before exposing the adhesive side 20a. The release liner 50 can then be peeled away in a controlled manner to enable the user to carefully and controllably adhere the tape 20 to a work piece.

According to an alternative embodiment of the present invention, the release liner 50 is omitted. In such an embodiment, the guide tape 10 is rolled onto itself, as is the case with conventional single-sided tape. A side 20b of the tape 20 opposite the adhesive side 20a therefore functions as a release liner. To ensure easy separation, side 20b may also be threaded with a release coating, such as silicone.

In the illustrated embodiments, the wires 30, 40, 30′, 40′ connect to the tape 20 via the adhesive on the adhesive side 20a of the tape 20. However, the wires 30, 40 may alternatively connect to the tape 20 in any other suitable way. For example, the wires 30, 40 may adhere to the other side 20b of the tape 20 (e.g., via glue, heat melting, etc.). Alternatively, the wires 30, 40 may be integrally formed with the tape 20 such that the wires 30, 40 simply comprise thicker regions of the tape 20. Alternatively, the wires 30, 40 may be sandwiched between two tape layers that together define the tape 20. Alternatively and/or additionally, the wires 30, 40 may be coated in an adhesive that improves adhesion between the wires 30, 40 and the tape 20 and may also improve adhesion between the wires 30, 40 and the work piece to more rigidly define the straight cutting path 60 relative to the work piece.

As shown in FIG. 1, length indicia 100 are printed or otherwise formed on the guide tape 10. The illustrated length indicia 100 comprise transverse hash marks that are longitudinally spaced from each other by predetermined distances. Thicker and/or wider hash marks may indicate larger length increments (e.g., foot, meter, decimeter), while thinner, fainter, and/or shorter hash marks may indicate smaller length measurements (e.g., inch, cm). Even smaller increments (e.g., ½ inch, ¼ inch, ½ cm, mm, etc.) may be also be shown using even thinner, fainter, and/or shorter hash marks. Any suitable indicia may be used to identify length measurements and/or differentiate larger and smaller increments (e.g., dotted v. dashed lines, different colored lines, alpha-numeric indicators, etc.). The length indicia 100 help a user to easily cut a precise length along the cutting path 60. The length indicia 100 may include both English and metric units.

While the illustrated indicia 100 identify longitudinal length increments using transversely extending lines, the indicia 100 may additionally and/or alternatively indicate transverse length increments using longitudinally extending lines that are parallel to the wires 30, 40. Such longitudinal lines may help the user to position the cutting path 60 at a precise transverse offset from another reference line. For example, such longitudinal lines may help a user cut a ½ inch overhang based on a sewing line on a piece of fabric.

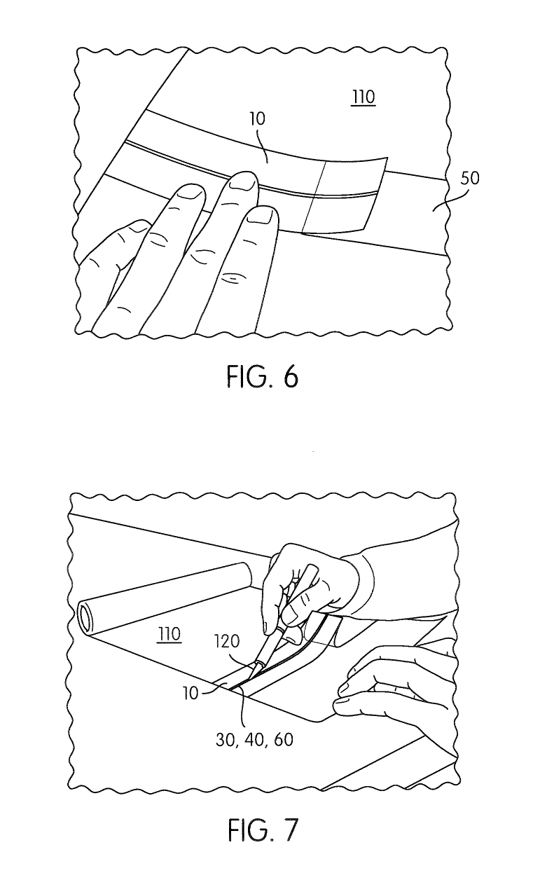

FIGS. 4-8 chronologically illustrate the use of the guide tape 10. As shown in FIG. 4, the user first cuts a selected length of guide tape 10 from a roll of guide tape 10. As shown in FIG. 5, the user then begins to peel the release liner 50 away from the guide tape 10 at a forward longitudinal end of the guide tape 10. As shown in FIG. 6, the user then adheres the guide tape 10 to a work piece 110 while continuing to peel back the release liner 50. The user adheres the guide tape 10 to the work piece 110 such that the cutting path 60 follows a straight desired line. Because the adhesive tape 20 is transparent, the user can align the cutting path 60 with the desired cut path on the work piece. The user may reposition the tape 10 if needed prior to cutting the work piece 110. Finally, as shown in FIG. 7, the user uses a knife blade 120 to cut the work piece 110 along the cutting path 60 between the wires 30, 40. The wires 30, 40 tend to keep the blade 120 between the wires 30, 40 and on the cutting path 60 to help the user cut a straight line on the work piece 110.

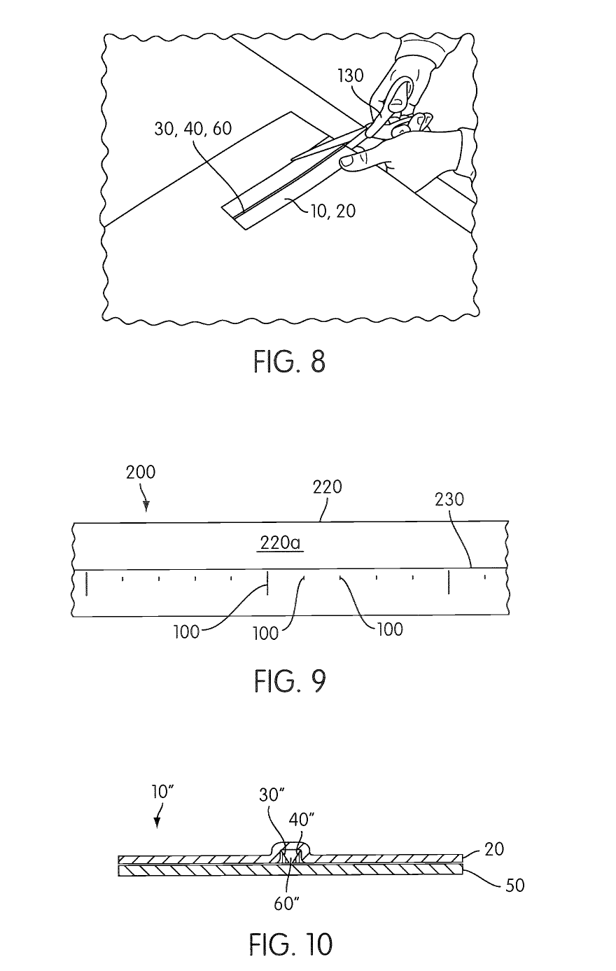

As shown in FIG. 8, the user may alternatively use another type of cutting device, in this embodiment a pair of scissors 130, to cut along the cutting path 60. The wires 30, 40 guide the blades of the scissors 130 to cut along the cutting path 60.

In the embodiments illustrated in FIGS. 6-8, the work piece 110 comprises a sheet of paper. However, embodiments of the present invention may alternatively be used to cut a variety of other types of work pieces (e.g., card stock, vinyl, acrylic, glass, cardboard, drywall, fabric, shelf liner, poster board, foamcore, plastic, etc.) without deviating from the scope of the present invention. In the case of acrylic and glass, the cutting device may score the work piece, rather than cut completely through the work piece. Once scored, the work piece may be broken along the score line.

The adhesive on the adhesive side 20a of the tape 20 may be specifically tailored for use with a particular type of work piece. For example, if the guide tape 10 is used with fabric, the adhesive preferably comprises a type of adhesive that will not leave an adhesive residue on the fabric. However, in other embodiments, an adhesive residue may not be problematic. In still other embodiments where the tape 20 may remain permanently adhered to the work piece (e.g., for additional structural support to the work piece), the adhesive may be a permanent adhesive.

FIG. 9 illustrates guide tape 200 according to an alternative embodiment of the present invention. The guide tape 200 comprises an adhesive tape 220 with an adhesive side 220a. A linear indicia 230 is printed or otherwise formed on the adhesive tape 220. When the guide tape 200 is adhered to a work piece, the linear indicia provides a cutting or marking guide that helps a user cut along a straight line indicated by the longitudinally extending linear indicia 230. The guide tape 200 may replace the use of other straight line generators such as a chalk line or a straight edge. As with the guide tape 10, the guide tape 200 may include length indicia 100.

According to an alternative embodiment, the guide elements need not necessarily be straight. For example, in crafting/scrap booking, users often desire to cut wavy borders, patterns, or edges. Thus, the guide elements may be arranged in such a manner. Likewise, the guide elements could be provided on sheets of adhesive tape and arranged in a variety of shapes, such as arcs or in closed loops to create geometric shapes (e.g., circles, triangles, squares, polygons, letters, numbers, etc.). Such sheets need not be wound in a roll. A wide variety of shapes could be included in a kit. While the guide elements are not straight, the guide elements preferably remain a fixed distance from each other to maintain a constant width cutting path.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A cutting guide comprising:
a substrate carrying an adhesive; and
first and second guide elements connected to the substrate, the guide elements being elongated and extending parallel to each other for receiving and guiding a cutting device therebetween.

2. The cutting guide according to claim 1, wherein the first and second guide elements are connected to the substrate via the adhesive.

3. The cutting guide according to claim 1, wherein the first and second guide elements comprise wires.

4. The cutting guide according to claim 1, further comprising a release liner releasably adhered to the adhesive.

5. The cutting guide according to claim 4, wherein the first and second guide elements are disposed between the adhesive and the release liner.

6. The cutting guide according to claim 1, wherein the first and second guide elements have triangular cross-sections.

7. The cutting guide according to claim 1, wherein the first and second guide elements have right-triangular cross sections.

8. The cutting guide according to claim 1, wherein facing sides of the first and second guide elements slope toward each other to define a valley therebetween.

9. The cutting guide according to claim 1, wherein the first and second guide elements have generally rectangular cross-sections.

10. The cutting guide according to claim 1, wherein:
the first guide element has a first generally planar side; and
the second guide element has a second generally planar side.

11. The cutting guide according to claim 10, wherein the first and second generally planar sides face each other and are generally parallel to each other.

12. The cutting guide according to claim 1, wherein the first and second guide elements touch each other.

13. The cutting guide according to claim 1, wherein the first and second guide elements are spaced from each other by less than 1/16 inch.

14. The cutting guide according to claim 1, wherein the first and second guide elements are non-metallic.

15. The cutting guide according to claim 1, wherein the first and second guide elements comprise a thermoplastic material.

16. The cutting guide according to claim 1, wherein the first and second guide elements comprise one of nylon and polyester.

17. A method of cutting a work piece using a cutting guide that comprises a substrate carrying an adhesive, and first and second guide elements connected to the substrate, the guide elements being elongated and extending parallel to each other for receiving and guiding a cutting device therebetween, the method comprising:
adhering the adhesive to the work piece; and
cutting the work piece between the first and second guide elements while using the first and second guide elements to physically guide the cutting.

18. The method of claim 17, wherein the cutting device comprises a knife blade.

19. The method of claim 17, wherein the cutting device comprises a scissors.
